(19) United States
(12) Patent Application Publication
(10) Pub. No.: US 2026/0312022 A1
(43) Pub. Date: Oct. 8, 2026

(54) COIN-SHAPED LITHIUM PRIMARY BATTERY

(71) Applicant: Panasonic Intellectual Property Management Co., Ltd., Osaka (JP)

(72) Inventors: TOMOHIRO YAGISHITA, Osaka (JP); TOMOHIRO KIKO, Osaka (JP); KOHEI SAITO, Osaka (JP)

(21) Appl. No.: 19/482,248

(22) PCT Filed: Jan. 22, 2024
(86) PCT No.: PCT/JP2024/001672

§ 371 Date: Nov. 7, 2025

(30) Foreign Application Priority Data
May 18, 2023 (JP) 2023-082562

(51) Int. Cl. H01M 4/50; H01M 4/62

(52) U.S. Cl. CPC H01M 4/502; H01M 4/623; H01M 4/625

(57) ABSTRACT

A coin-shaped lithium primary battery includes a positive electrode, a negative electrode, a separator disposed between the positive electrode and the negative electrode, and an electrolytic solution. The positive electrode contains manganese dioxide, graphite, a binder, and a boron compound. A thickness T (mm) of the positive electrode and an average length (mm) of a long axis of the graphite satisfy Formula (1): 0.02≤T (mm)×DL (mm)≤0.12.

### BACKGROUND

### 1. Technical Field

The present disclosure relates to a coin-shaped lithium primary battery.

### 2. Description of the Related Art

Patent Literature 1 proposes “a non-aqueous battery including an active metal negative electrode, a positive electrode, and an ion conductive electrolyte solution containing a solute dissolved in a non-aqueous electrolyte, wherein the solute is a salt of a first component of a halide of an element selected from the group consisting of Al, Sb, Zr, and P and a second component of a halide, a sulfide, a sulfite, an oxide, or a carbonate of calcium or an alkali metal selected from the group consisting of Li, Na, and K, and the active metal negative electrode has a surface layer of a boron-containing material”.

Patent Literature 2 proposes “a lithium primary battery including a positive electrode made of manganese dioxide, a negative electrode made of lithium or a lithium alloy, and an electrolytic solution, wherein manganese dioxide to which boron is added is used as the manganese dioxide, and butylene carbonate is contained as a solvent of the electrolytic solution”.

Patent Literature 3 proposes “a non-aqueous electrolyte battery including a positive electrode, a negative electrode, and an electrolyte, in which the positive electrode includes a positive electrode mixture containing electrolytic manganese dioxide as an active material, expanded graphite as a conductive agent, and a binder, and a ratio of a median diameter of the expanded graphite to a median diameter of the electrolytic manganese dioxide is 1.5 to 3”.

### CITATION LIST

### Patent Literature

Patent Literature 1: Unexamined Japanese Patent Publication No. S59-117070
Patent Literature 2: Unexamined Japanese Patent Publication No. 2007-134270
Patent Literature 3: Unexamined Japanese Patent Publication No. 2019-102152

### SUMMARY

A coin-shaped lithium primary battery has a sealed structure, but internal resistance (hereinafter, referred to as IR) during storage increases significantly. The main cause of the IR increase is a phenomenon in which moisture in the outside air intruding from the outside reacts with the negative electrode to form an inert film on the surface of the negative electrode. Since a coin-shaped battery has a small internal volume and tends to have a high concentration of intruding moisture, an inert film is formed in a short period of time, and IR may significantly increase.

In view of the above, one aspect of the present disclosure relates to a coin-shaped lithium primary battery including a positive electrode, a negative electrode, a separator disposed between the positive electrode and the negative electrode, and an electrolytic solution, in which the positive electrode contains manganese dioxide, graphite, a binder, and a boron compound, and a thickness T (mm) of the positive electrode and an average length DL (mm) of a long axis of the graphite satisfy Formula (1): 0.02≤T (mm)×DL (mm)≤0.12.

The coin-shaped lithium primary battery according to the present disclosure can suppress an increase in internal resistance due to intruding moisture during storage.

### BRIEF DESCRIPTION OF DRAWINGS

FIG. 1 is a longitudinal sectional view of a coin-shaped lithium primary battery according to an embodiment of the present disclosure.

### DESCRIPTION OF EMBODIMENT

Hereinafter, an embodiment of the present disclosure will be described with reference to examples, but the present disclosure is not limited to the examples described below. In the following description, specific numerical values and materials may be exemplified, but other numerical values and materials may be applied as long as the effects of the present disclosure are obtained. Constituent elements of a known secondary battery may be applied to constituent elements other than the characteristic portions of the present disclosure. In the present specification, when referring to “a range of a numerical value A to a numerical value B”, the numerical value A and the numerical value B are included in the range. In the following description, when a lower limit and an upper limit are exemplified with respect to numerical values of specific physical properties and conditions, any of the exemplified lower limits and any of the exemplified upper limits can be arbitrarily combined as long as the lower limit is not equal to or greater than the upper limit.

The disclosure encompasses any combination of two or more claimed subject matter arbitrarily selected from the appended claims. That is, the matters described in two or more claims arbitrarily selected from a plurality of claims described in the appended claims can be combined as long as no technical contradiction arises.

A coin-shaped lithium primary battery according to the embodiment of the present disclosure includes, as power generation elements, a positive electrode, a negative electrode, a separator disposed between the positive electrode and the negative electrode, and an electrolytic solution. The power generation element is hermetically housed in a predetermined exterior body.

The positive electrode is formed by pressure-molding a positive electrode mixture into a predetermined shape. The positive electrode mixture contains manganese dioxide, graphite, a binder, and a boron compound. The shape of the positive electrode is a pellet shape or a cylindrical shape (disk shape) corresponding to the shape of the coin-shaped lithium primary battery. The thickness T of the positive electrode is not particularly limited, but is, for example, 400 μm or more and 2000 μm or less.

The negative electrode is formed, for example, by processing a metal sheet or a metal foil into a predetermined shape. At least one of lithium metal or a lithium alloy can be used for the metal sheet. Examples of the lithium alloy include a lithium-aluminum alloy, a lithium-tin alloy, a lithium-silicon alloy, and a lithium-lead alloy. The shape of the negative electrode is a disk shape corresponding to the shape of the coin-shaped lithium primary battery. A foil of lithium metal or lithium alloy may be punched into a circular shape and used for the negative electrode.

The exterior body includes, for example, a case having a bottom plate portion and a side portion rising from a peripheral edge of the bottom plate portion, an outer surface of the case having a first terminal surface, a sealing plate having a top plate portion and a peripheral edge portion extending from the top plate portion to an inside of the side portion of the case, an outer surface of the sealing plate having a second terminal surface, and a gasket compressed and interposed between the side portion and the peripheral edge portion. An end portion of the side portion of the case is swaged to the sealing plate via a gasket.

In the exterior body, mainly the following three reactions competitively proceed on the surface of the negative electrode.
(A) A reaction of forming a non-conductive film (A) due to a reaction between the intruding water and the surface of the negative electrode.
(B) A reaction of forming an intermediate film (B) due to a reaction between a boron-containing intermediate produced due to contact between a boron compound and manganese dioxide and a negative electrode surface.
(C) A reaction of forming a film (C) due to a reaction between a boron-containing product generated from the boron-containing intermediate and the surface of the negative electrode.

The boron-containing intermediate may be present in various forms, but is believed to be an ionic species produced due to decomposition of a boron compound due to the catalytic action of manganese dioxide. The intermediate film (B) formed due to the reaction of the boron-containing intermediate with the surface of the negative electrode has a lower resistance than the water-derived non-conductive film (A) formed due to the reaction of water with the surface of the negative electrode, and can suppress an increase in internal resistance (IR), but the suppression is not sufficient.

The boron-containing product may be present in various forms; however, the analysis results, it is believed that the boron-containing product is present in the electrolyte solution mainly as ionic species such as Li₂BO₂ cations and LiBO₂ anions. Hereinafter, the boron-containing product may be referred to as “LBO ions”.

The film (C) formed due to the reaction of LBO ions with the surface of the negative electrode suppresses an increase in IR by reacting sacrificially with water. That is, it is believed that the film (C) repeats formation and disappearance. Therefore, the film (C) has little influence on the battery reaction and suppresses the formation of a non-conductive film derived from water. Since the positive electrode contains a boron compound, LBO ions necessary for repairing the film (C) are continuously supplied. As a result, an increase in internal resistance due to moisture intruding the battery during storage is significantly suppressed.

Here, the thickness T (mm) of the positive electrode and the average length DL (mm) of the long axis of the graphite satisfy the following formula (1).

$$0.02 ≦ T ( mm ) \times DL ( mm ) ≦ 0.12 \qquad Formula ( 1 )$$

The product (T·DL) of T and DL in mm is 0.02 or more, may be 0.04 or more, and may be 0.05 or more. The larger the T·DL, the thicker the positive electrode and the flatter the graphite particles.

The boron compound migrates in the electrolytic solution in the positive electrode while repeatedly contacting manganese dioxide. The basal plane of the flat graphite particles serves as a barrier to the migration of the boron compound. Since the boron compound migrates while bypassing the graphite particles, the migration path in the positive electrode becomes longer. Therefore, the frequency of contact between the boron compound and manganese dioxide increases, and a larger amount of the boron compound transforms into a boron-containing intermediate, further transforms into LBO ions, and then reaches the negative electrode surface. As a result, the “reaction of forming a good conductor film due to the reaction between the boron-containing product generated from the boron-containing intermediate and the surface of the negative electrode” of the above (C) becomes more dominant. That is, as T·DL increases, the reaction of (C) becomes more dominant.

Since the electrolytic solution is abundant in the separator, the boron-containing product that reaches the electrolytic solution in the separator can quickly reach the surface of the negative electrode.

On the other hand, T·DL is 0.12 or less, may be 0.10 or less, and may be 0.09 or less. This is because when T·DL is too large, the positive electrode becomes excessively thick or the graphite particles become excessively flat. When T·DL is too large, the moving path of LBO ions in the positive electrode becomes too long, and the “reaction of forming a non-conductive film due to a reaction between intruding moisture and the surface of the negative electrode” of the above (A) becomes more dominant. That is, even if T·DL is too large, it is difficult to suppress an increase in IR of the battery.

Graphite has a basal plane and an edge surface. The basal plane is a plane that determines the length of the long axis of graphite. The edge surface is an end surface of the layered structure and is much shorter than the basal plane. That is, most of the graphite particles have a flat shape having a long axis and a short axis. The average length (DL) of the long axis and the average length (DW) of the short axis can be measured, for example, by the following procedure using a scanning electron micrograph (hereinafter, referred to as SEM image) of a cross section of the positive electrode. The aspect ratio of graphite is defined by the ratio DL/DW.
(1) Arbitrary 200 or more graphite particles are selected from the SEM image.
(2) Among rectangles each surrounding the graphite particle, the rectangle with the smallest area (hereinafter, referred to as rectangle min) is determined.
(3) The length of the long side of the rectangle min is measured as the length (dL) of the long axis of the particle.
(4) The length of the short side of the rectangle min is measured as the length (dW) of the short axis of the particle.
(5) The lengths (dL) of the long sides of the rectangles min of 200 or more particles are averaged to obtain the average length (DL) of the long axis. DL is generally 10 μm to 100 μm, and may be 20 μm to 80 μm.
(6) The lengths (dW) of the short sides of the rectangles min of 200 or more particles are averaged to obtain the average length (DW) of the short axis. DW is generally 0.1 μm to 5 μm, may be 0.5 μm to 4 μm, and may be 1 μm to 3 μm.
(7) The aspect ratio is determined as the ratio of DL/DW. The aspect ratio is generally 2 to 1,000, and may be 5 to 800.

Graphite acts as a conductive aid. Since the positive electrode mixture contains graphite, an electron conduction path in the positive electrode is sufficiently secured, and sufficient output is secured.

The graphite may comprise expanded graphite. The particles of expanded graphite have a flat shape. The expanded graphite is prepared, for example, by inserting sulfuric acid between the layers of the basal planes of graphite and then foaming the graphite. Expanded graphite has a large interplanar spacing in the c-axis direction perpendicular to the basal plane, is easily exfoliated, and is likely to have a flat shape. The interplanar spacing (d002) of the (002) plane of the expanded graphite obtained by a powder X-ray diffraction method using CuKα rays may be, for example, 3.37 Å or more. The crystallite size Lc (002) in the c-axis direction may be, for example, 500 Å or less. The expanded graphite contains a trace amount of remaining sulfate ions (SO₃⁻).

The interplanar spacing (d002) is determined from Bragg's equation (λ=2d×sin θ) by an X-ray diffraction method.
λ: wavelength of CuKα ray (=0.15418 nm)
d: average interplanar spacing d002 of (002) planes
θ: ½ angle (rad) of 2θ of the peak position obtained by the centroid method

The crystallite size Lc (002) can be calculated from the half-width of the X-ray diffraction peak attributed to the (002) plane using the Scherrer equation (D (nm)=0.9×λ/(β×cos θ)).
λ=wavelength of CuKα
β=half-width of the peak (rad)
θ=½ angle (rad) of 2θ of the peak position obtained by the centroid method

The content of graphite contained in the positive electrode (that is, the positive electrode mixture) is, for example, preferably 1% by mass or more and 10% by mass or less, and more preferably 1% by mass or more and 5% by mass or less. When the content of graphite is 1% by mass or more, the migration path of the boron compound or the boron-containing intermediate becomes sufficiently long, and a sufficient amount of LBO ions can reach the surface of the negative electrode. When the content of graphite is 10% by mass or less, the migration path of the boron compound or the boron-containing intermediate does not become excessively long, and it is possible to avoid the formation of a non-conductive film derived from water becoming dominant. In addition, when the content of graphite is 1% by mass or more and 10% by mass or less, it is possible to secure the positive electrode capacity and to sufficiently secure the action as a conductive auxiliary agent. The content of the expanded graphite in the graphite is, for example, 80% by mass or more, may be 90% by mass or more, and may be 100%.

The boron compound is a source of LBO ions. The boron compound may be, for example, at least one selected from the group consisting of a boron oxide and a lithium-containing boron oxide. It is believed that, regardless of the type of the boron compound, LBO ions (ionic species such as Li₂BO₂ cations and LiBO₂ anions) are eventually generated in the electrolytic solution as a boron-containing product. In particular, it is highly likely that ionic species having a LiBO₂ structure are generated in the electrolytic solution in the positive electrode, and it is believed that the LiBO₂ structure is maintained even in the film on the surface of the negative electrode.

The presence of LBO ions can be investigated by, for example, estimating the state of boron element in the film by time-of-flight secondary ion mass spectrometry (hereinafter, referred to as TOF-SIMS).

As the boron compound blended in the positive electrode mixture, for example, at least one selected from the group consisting of B₂O₃, Li₂B₄O₇, Li₃BO₃, and LiBO₂ can be used. Any of these is suitable as a supply source of LBO ions. Among them, at least one selected from the group consisting of B₂O₃ and LiBO₂ is considered to be most suitable as a supply source of LBO ions at present.

The content of the boron compound contained in the positive electrode is, for example, 0.5% by mass or more and 5% by mass or less, and may be 0.8% by mass or more and 3% by mass or less. When the content of the boron compound is 0.5% by mass or more, it is sufficient to continuously supply LBO ions necessary for repairing the film (C). As a result, an increase in internal resistance due to moisture intruding the battery during storage is significantly suppressed. When the content of the boron compound is 5% by mass or less, it is possible to secure the positive electrode capacity and to maximize the effect of suppressing an increase in internal resistance.

The ratio Ve/(Vp+Vs) based on the volume Ve of the electrolytic solution in the battery and the total volume Vt of the void volume Vp of the positive electrode and the void volume Vs of the separator, that is, Ve/Vt is preferably 0.9 or more and 1.5 or less, and more preferably 1.0 or more and 1.2 or less.

When the volume Ve of the electrolytic solution in the battery increases and the Ve/Vt ratio exceeds 1.5, a part of the electrolytic solution may be present outside the power generation element without being impregnated into the positive electrode, the separator, and the negative electrode. The boron compound eluted from the positive electrode into the electrolytic solution can migrate through the electrolytic solution present outside the power generation element and reach the surface of the negative electrode. Therefore, the boron compound or the boron-containing intermediate before being converted into LBO ions may react on the surface of the negative electrode, resulting in insufficient formation of a film derived from LBO ions. On the other hand, when the volume Ve of the electrolytic solution in the battery is small and the Ve/Vt ratio is less than 0.9, the migration of LBO ions in the positive electrode becomes slow, the formation reaction of the non-conductive film of (A) becomes dominant, and it may be difficult to suppress an increase in IR of the battery.

The volume Ve of the electrolytic solution in the battery can be obtained from the mass of the electrolytic solution contained in the battery and the specific gravity of the electrolytic solution. The mass of the electrolytic solution can be obtained by disassembling the battery, drying the power generation element, and calculating the mass difference between the battery mass before the disassembly and the battery mass after the disassembly and drying.

The void volume Vp of the positive electrode can be measured, for example, by the following procedure using a scanning electron micrograph (SEM image) of a cross section of the positive electrode.
(1) An SEM image including a cross section of the positive electrode (positive electrode mixture) having a sufficient size is captured.
(2) An area Se occupied by the electrolytic solution or the voids in an area Sp of a cross section of a predetermined positive electrode (positive electrode mixture) is obtained by image processing.
(3) The void volume Vp of the positive electrode is determined as Vp=Sp×Se/Sp.

The void volume Vs of the separator can be measured, for example, by the following procedure using a scanning electron micrograph (SEM image) of a cross section of the separator.
(1) An SEM image including a cross section of the separator having a sufficient size is captured.
(2) An area Sse occupied by the electrolytic solution or the voids in an area Ss of a cross section of a predetermined separator is obtained by image processing.
(3) The void volume Vs of the separator is determined as Vs=Ss×Sse/Ss.

The electrolytic solution contains a non-aqueous solvent and a solute (salt). The solute concentration in the electrolytic solution is, for example, 0.3 mol/L to 2 mol/L. As the non-aqueous solvent, propylene carbonate, ethylene carbonate, or 1,2-dimethoxyethane can be used. These may be used alone or in combination of two or more. As the solute, LiClO₄, LiPF₆, LiBF₄, LiCF₃SO₃, or LiN(CF₃SO₂)₂ can be used. These may be used alone or in combination of two or more.

The manganese dioxide may be electrolytic manganese dioxide. The electrolytic manganese dioxide may be sintered after neutralization with an alkali. For example, electrolytic manganese dioxide may be sintered in air or oxygen at 300 to 450° C. for about 6 to 12 hours. By sintering, moisture is volatilized, crystallization proceeds, and in addition, the specific surface area also decreases. Therefore, the structural stability and water reaction resistance of manganese dioxide are improved. When unsintered electrolytic manganese dioxide is used, the specific surface area may be decreased by increasing the crystallinity depending on the conditions during electrolytic synthesis.

The volume-based median diameter (D50) of manganese dioxide measured with a laser diffraction scattering type measuring device is, for example, 20 μm to 50 μm, may be 20 μm to 45 μm, and may be 20 μm to 35 μm. When the median diameter of manganese dioxide is 20 μm or more, the frequency of contact between graphite and the boron compound in the positive electrode increases, and the number of contact points between active materials also increases. On the other hand, when the median diameter of manganese dioxide is 50 μm or less, the pressure required for forming the positive electrode mixture is decreased, and the filling density can be easily increased.

As the binder, for example, a fluororesin, rubber particles, or an acrylic resin is used. As the fluororesin, polytetrafluoroethylene (hereinafter, also referred to as “PTFE”), tetrafluoroethylene-hexafluoropropylene copolymer, and polyvinylidene fluoride are used. Styrene butadiene rubber (hereinafter, referred to as SBR) and modified acrylonitrile rubber are used as the rubber particles. Examples of the acrylic resin include an ethylene-acrylic acid copolymer. The binder may be used alone or in combination of two or more.

Among the binders, a fibrous fluororesin is preferable. The fibrous fluororesin does not excessively cover the surface of the manganese dioxide and does not significantly inhibit the contact between the surface of the manganese dioxide and the electrolytic solution (furthermore, the boron compound or the boron-containing intermediate). The fibrous fluororesin may be a fluororesin that is not dissolved in N-methyl-2-pyrrolidone (hereinafter, referred to as NMP) and is dispersed as particles. The fibrous fluororesin may be a fluororesin that is fibrillated by a pressure applied to the positive electrode mixture when the positive electrode is produced.

Among fibrous fluororesins, for example, PTFE is preferable. PTFE is a fluororesin containing a tetrafluoroethylene unit (—CF₂CF₂—) as a main component. The content of the tetrafluoroethylene unit in the PTFE is, for example, 90 mol % or more, and may be 95 mol % or more. The weight average molecular weight Mw of the PTFE may be, for example, 200,000 to 800,000.

The content of the binder contained in the positive electrode is, for example, 1% by mass or more and 10% by mass or less, and may be 1% by mass or more and 5% by mass or less. When the content of the binder is 1 mass % or more, it is possible to ensure sufficient positive electrode capacity and sufficient strength of the positive electrode. When the content of the binder in the positive electrode is 10 mass % or less, it is possible to ensure the positive electrode capacity sufficiently and to maximize the effect of suppressing an increase in internal resistance. The percentage content of PTFE in the binder is, for example, 80 mass % or more, may be 90 mass % or more, and may be 100%.

The separator may be made of any material that can prevent a short circuit between the positive electrode and the negative electrode and can hold the electrolytic solution. Examples thereof include woven fabrics, nonwoven fabrics, and microporous films formed of polyolefin or polyester. In particular, a nonwoven fabric made of polypropylene is preferable.

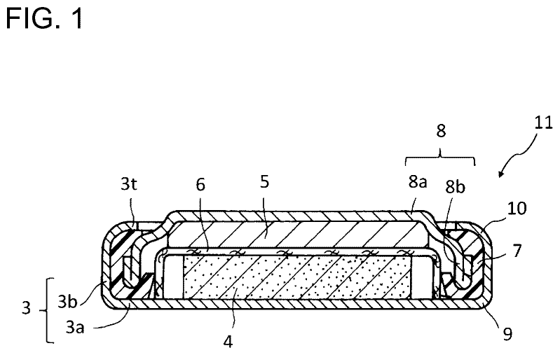

FIG. 1 is a longitudinal sectional view of a coin-shaped lithium primary battery according to the embodiment of the present disclosure. The coin-shaped battery 11 includes an exterior body including a case 3, a sealing plate 8, and a gasket 7. The case 3 is a cylindrical shallow battery can having a bottom plate portion 3a and a side portion 3b rising from a peripheral edge of the bottom plate portion 3a via a first curved portion 9. The sealing plate 8 includes a top plate portion 8a and a peripheral edge portion 8b extending from the top plate portion 8a to the inside of the side portion 3b of the case 3. An end portion 3t (opening end portion) of the side portion 3b of the case 3 is curved inward at the second curved portion 10 and swaged to the peripheral edge portion 8b of the sealing plate 8 via the gasket 7, thereby sealing the gap between the case 3 and the sealing plate 8.

A power generation element is housed inside the exterior body. The power generation element includes a positive electrode 4, a negative electrode 5, a separator 6, and an electrolytic solution. In the illustrated example, the positive electrode 4 is disposed so as to face the bottom plate portion 3a of the case 3. Therefore, the outer surface of the bottom plate portion 3a functions as a positive electrode terminal surface. On the other hand, the negative electrode 5 is disposed so as to face the top plate portion 8a of the sealing plate 8. Therefore, the outer surface of the top plate portion 8a functions as a negative electrode terminal surface.

Although an example of a coin-shaped lithium primary battery has been described above, the form of the battery is not particularly limited. The thickness and diameter of the battery are not particularly limited. The coin-shaped lithium primary battery also includes a button-type lithium primary battery.

### Notes

The following techniques are disclosed by the above description.

### Technique 1

A coin-shaped lithium primary battery comprising:
a positive electrode; a negative electrode; a separator disposed between the positive electrode and the negative electrode; and an electrolyte solution,
wherein the positive electrode contains manganese dioxide, graphite, a binder and a boron compound, and
a thickness T (mm) of the positive electrode and an average length DL (mm) of a long axis of the graphite satisfy the following formula:

0.02≤T (mm)×DL (mm)≤0.12.

### Technique 2

The coin-shaped lithium primary battery of Technique 1, wherein the graphite comprises expanded graphite.

### Technique 3

The coin-shaped lithium primary battery according to Technique 1 or 2, wherein a content of the graphite contained in the positive electrode is 1% by mass or more and 10% by mass or less.

### Technique 4

The coin-shaped lithium primary battery according to any one of Techniques 1 to 3, wherein the boron compound is at least one selected from the group consisting of a boron oxide and a lithium-containing boron oxide.

### Technique 5

The coin-shaped lithium primary battery according to any one of Techniques 1 to 4, wherein the boron compound is at least one selected from the group consisting of B₂O₃, Li₂B₄O₇, Li₃BO₃, and LiBO₂.

### Technique 6

The coin-shaped lithium primary battery according to any one of Techniques 1 to 5, wherein a content of the boron compound contained in the positive electrode is 0.5% by mass or more and 5% by mass or less.

### Technique 7

The coin-shaped lithium primary battery according to any one of Techniques 1 to 6, wherein a ratio of a volume of the electrolytic solution/(a void volume of the positive electrode+a void volume of the separator) is 0.9 or more and 1.5 or less.

### Technique 8

The coin-shaped lithium primary battery according to any one of Techniques 1 to 7, wherein the binder includes a fibrous fluororesin.

### Technique 9

The coin-shaped lithium primary battery of Technique 8, wherein the fibrous fluororesin comprises polytetrafluoroethylene.

### EXAMPLES

Hereinafter, the present disclosure will be specifically described based on Examples. However, the following examples do not limit the present invention. In the present examples, coin-shaped lithium primary batteries each having a structure as shown in FIG. 1 were produced.

### Inventive Example 1

### (1) Positive Electrode

As a positive electrode active material, sintered electrolytic manganese dioxide was prepared by sintering electrolytic manganese dioxide in air at 400° C. for 10 hours. Ninety-five parts by mass of sintered manganese dioxide, 2 parts by mass of expanded graphite (average length (DL) of the long axis determined by the method described above after disassembling the produced battery: 0.06 mm), and 1 part by mass of LiBO₂ were dry-mixed. Next, an aqueous dispersion containing 2 parts by mass of PTFE was added to the obtained mixed powder, followed by wet mixing. The obtained mixture was dried to obtain a positive electrode mixture. The positive electrode mixture was tablet-molded into a cylindrical shape having a diameter of 15 mm and a thickness (T) of 0.35 mm (T·DL=0.021) to produce a positive electrode. The cylindrical positive electrode pellet was dried at 250° C. for 8 hours.

### (2) Negative Electrode

A lithium metal foil having a thickness of 0.15 mm was punched into a circular shape having a diameter of 16 mm to produce a negative electrode.

### (3) Electrolyte Solution

Lithium perchlorate (LiClO₄) as a solute was dissolved at a concentration of 1.0 mol/L in a non-aqueous solvent obtained by mixing propylene carbonate and 1,2-dimethoxyethane at a volume ratio of 2:1 to obtain an electrolytic solution.

### (4) Case

SUS430 (thickness: 250 μm) having a nickel plating layer with a thickness of 3 μm on the surface thereof was drawn to produce a case having a bottom plate portion with a diameter of 20 mm and a side portion 1b with a height of 1.1 mm.

### (5) Sealing Plate

SUS430 (thickness: 250 μm) having a nickel plating layer with a thickness of 3 μm on the surface thereof was pressed to produce a sealing plate 8 having a top plate portion 8a with a diameter of 17 mm.

### (6) Assembly of Coin-Shaped Battery

A polypropylene gasket was disposed on the sealing plate. The negative electrode was attached to the inside of the top plate portion of the sealing plate. Next, a polypropylene nonwoven fabric having a thickness of 300 μm was placed on the negative electrode as a separator. Thereafter, the positive electrode was placed on the separator. Thereafter, the electrolyte solution was injected into the sealing plate. A sealant including blown asphalt and mineral oil was applied to the inside of a side portion of a case in advance, and the case was covered with a sealing plate. Then, an end portion of the side portion of the case was curved inward and swaged to a peripheral edge portion of the sealing plate with a gasket interposed therebetween, thereby fabricating a coin-shaped battery (Battery E1).

The thickness of the assembled battery is 1.2 mm. The assembled battery (about 3.5 V) was preliminarily discharged by a predetermined electric capacity so that the battery voltage became 3.2 V. The battery capacity after the preliminary discharge is 230 mAh when the discharge capacity up to 2 V is measured when constant resistance discharge (15 kΩ) is performed.

The ratio of the volume (Ve) of the electrolytic solution in the battery to the void volume (Vp) of the positive electrode+the void volume (Vs) of the separator was Ve/(Vp+Vs)=Ve/Vt=1.2.

### Inventive Examples 2 to 8

Batteries E2 to E8 were produced in the same manner as in the inventive example 1, except that the battery diameter, the battery thickness, the thickness (T) of the positive electrode, the average length (DL) of the long axis of the expanded graphite, and T·DL were changed as shown in Table 1A.

### Comparative Examples 1 to 5

Batteries R1 to R5 were produced in the same manner as in the inventive example 1, except that the battery diameter, the battery thickness, the thickness (T) of the positive electrode, the average length (DL) of the long axis of the expanded graphite, and T·DL were changed as shown in Table 1B.

### [Battery Evaluation]

Ten of each of the produced batteries were stored in an environment at 60° C. and a relative humidity of 90% for 100 days. After the storage, the AC internal resistance was measured at room temperature under the conditions of a voltage amplitude of 0.2 V and a frequency of 100 Hz.

The long-term storage of the coin-shaped battery at room temperature can be accelerated in a storage environment at 60° C. and a relative humidity of 90%. Storage for 100 days in such an environment is equivalent to storage at normal temperature for 10 years. The results of calculating the average value of the 10 batteries are shown in Tables 1A and 1B.

TABLE 1A

| | E1 | E2 | E3 | E4 | E5 | E6 | E7 | E8 |
|---|---|---|---|---|---|---|---|---|
| BATTERY | 20 | 20 | 20 | 20 | 20 | 20 | 20 | 23 |
| DIAMETER | | | | | | | | |
| (mm) | | | | | | | | |
| BATTERY | 1.2 | 1.6 | 1.6 | 3.2 | 3.2 | 3.2 | 5.0 | 5.4 |
| THICKNESS | | | | | | | | |
| (mm) | | | | | | | | |
| T | 0.35 | 0.70 | 0.70 | 2.00 | 2.00 | 2.00 | 3.00 | 3.50 |
| (mm) | | | | | | | | |
| DL | 0.06 | 0.04 | 0.08 | 0.02 | 0.04 | 0.06 | 0.04 | 0.02 |
| (mm) | | | | | | | | |
| T · DL | 0.021 | 0.028 | 0.056 | 0.040 | 0.080 | 0.120 | 0.120 | 0.070 |
| GRAPHITE | 2.0 | ← | ← | ← | ← | ← | ← | ← |
| CONTENT | | | | | | | | |
| (wt %) | | | | | | | | |
| B | LiBO₂ | ← | ← | ← | ← | ← | ← | ← |
| COMPOUND | | | | | | | | |
| GRAPHITE | EXPANDED | ← | ← | ← | ← | ← | ← | ← |
| | GRAPHITE | | | | | | | |
| Ve/Vt | 1.2 | ← | ← | ← | ← | ← | ← | ← |
| BINDER | PTFE | ← | ← | ← | ← | ← | ← | ← |
| INTERNAL | 52 | 50 | 43 | 38 | 35 | 60 | 55 | 35 |
| RESISTANCE | | | | | | | | |
| (Ω) | | | | | | | | |

Table 1A shows that the internal resistance remains low when 0.02≤T·DL≤0.12 is satisfied. It is believed that this is because a larger amount of the boron compound was converted into LBO ions and then reached the surface of the negative electrode in preference to the case where moisture reached the surface of the negative electrode and reacted.

TABLE 1B

| | R1 | R2 | R3 | R4 | R5 |
|---|---|---|---|---|---|
| BATTERY | 20 | 20 | 20 | 20 | 23 |
| DIAMETER | | | | | |
| (mm) | | | | | |
| BATTERY | 1.2 | 1.6 | 3.2 | 5.0 | 5.4 |
| THICKNESS | | | | | |
| (mm) | | | | | |
| T | 0.35 | 0.70 | 2.00 | 3.00 | 3.50 |
| (mm) | | | | | |
| DL | 0.04 | 0.02 | 0.08 | 0.06 | 0.04 |
| (mm) | | | | | |
| T/DL | 0.014 | 0.014 | 0.160 | 0.180 | 0.140 |
| GRAPHITE | 2.0 | ← | ← | ← | ← |
| CONTENT | | | | | |
| (wt %) | | | | | |
| B | LiBO₂ | ← | ← | ← | ← |
| COMPOUND | | | | | |
| GRAPHITE | EXPANDED | ← | ← | ← | ← |
| | GRAPHITE | | | | |
| Ve/Vt | 1.2 | ← | ← | ← | ← |
| BINDER | PTFE | ← | ← | ← | ← |
| INTERNAL | 120 | 105 | 130 | 120 | 110 |
| RESISTANCE | | | | | |
| (Ω) | | | | | |

Table 1B shows that the internal resistance increases significantly when T·DL<0.02 or 0.12<T·DL. This is probably because the reaction between moisture and the surface of the negative electrode is dominant over the reaction between LBO ions and the surface of the negative electrode.

### Inventive Examples 9 to 12

Batteries E9 to E12 were produced and evaluated in the same manner as in the inventive example 5, except that the total mass of the expanded graphite and manganese dioxide was kept constant and the content of the expanded graphite was changed as shown in Table 2. The results are shown in Table 2.

TABLE 2

| | E5 | E 9 | E 10 | E 11 | E 12 |
|---|---|---|---|---|---|
| BATTERY | 20 | ← | ← | ← | ← |
| DIAMETER | | | | | |
| (mm) | | | | | |
| BATTERY | 3.2 | ← | ← | ← | ← |
| THICKNESS | | | | | |
| (mm) | | | | | |
| T | 2.00 | ← | ← | ← | ← |
| (mm) | | | | | |
| DL | 0.04 | ← | ← | ← | ← |
| (mm) | | | | | |
| T/DL | 0.080 | ← | ← | ← | ← |
| GRAPHITE | 2.0 | 0.8 | 1.0 | 10.0 | 11.0 |
| CONTENT | | | | | |
| (wt %) | | | | | |
| B | LiBO₂ | ← | ← | ← | ← |
| COMPOUND | | | | | |
| GRAPHITE | EXPANDED | ← | ← | ← | ← |
| | GRAPHITE | | | | |
| Ve/Vt | 1.2 | ← | ← | ← | ← |
| BINDER | PTFE | ← | ← | ← | ← |
| INTERNAL | 35 | 53 | 44 | 42 | 51 |
| RESISTANCE | | | | | |
| (Ω) | | | | | |

Table 2 shows that the content of the expanded graphite contained in the positive electrode (positive electrode mixture) is preferably 1% by mass or more and 10% by mass or less.

### Inventive Examples 13 to 15

Batteries E13 to E15 were produced and evaluated in the same manner as in the inventive example 5, except that the type of the boron compound was changed as shown in Table 3. The results are shown in Table 3.

TABLE 3

| | E5 | E13 | E14 | E15 |
|---|---|---|---|---|
| BATTERY | 20 | ← | ← | ← |
| DIAMETER | | | | |
| (mm) | | | | |
| BATTERY | 3.2 | ← | ← | ← |
| THICKNESS | | | | |
| (mm) | | | | |
| T | 2.00 | ← | ← | ← |
| (mm) | | | | |
| DL | 0.04 | ← | ← | ← |
| (mm) | | | | |
| T/DL | 0.080 | ← | ← | ← |
| GRAPHITE | 2.0 | ← | ← | ← |
| CONTENT | | | | |
| (wt %) | | | | |
| B | LIBO₂ | B₂O₃ | Li₂B₄O₇ | Li₃BO₃ |
| COMPOUND | | | | |
| GRAPHITE | EXPANDED | ← | ← | ← |
| | GRAPHITE | | | |
| Ve/Vt | 1.2 | ← | ← | ← |
| BINDER | PTFE | ← | ← | ← |
| INTERNAL | 35 | 55 | 44 | 40 |
| RESISTANCE | | | | |
| (Ω) | | | | |

Table 3 shows that the effect of suppressing an increase in internal resistance is obtained regardless of the type of the boron compound contained in the positive electrode (positive electrode mixture), and that LiBO₂ is highly effective among the boron compounds.

### Inventive Examples 16 and 17

Batteries E16 and E17 were produced and evaluated in the same manner as in the inventive example 5, except that the type of graphite was changed to flake-shaped graphite or graphene having a long axis length DL of 0.04 mm as shown in Table 4. The results are shown in Table 4.

TABLE 4

| | E5 | E16 | E17 |
|---|---|---|---|
| BATTERY DIAMETER | 20 | ← | ← |
| (mm) | | | |
| BATTERY | 3.2 | ← | ← |
| THICKNESS | | | |
| (mm) | | | |
| T | 2.00 | ← | ← |
| (mm) | | | |
| DL | 0.04 | ← | ← |
| (mm) | | | |
| T/DL | 0.080 | ← | ← |
| GRAPHITE CONTENT | 2.0 | ← | ← |
| (wt %) | | | |
| B COMPOUND | LiBO₂ | ← | ← |
| GRAPHITE | EXPANDED | FLAKE- | GRAPHENE |
| | GRAPHITE | SHAPED | |
| | | GRAPHITE | |
| Ve/Vt | 1.2 | ← | ← |
| BINDER | PTFE | ← | ← |
| INTERNAL | 35 | 43 | 60 |
| RESISTANCE | | | |
| (Ω) | | | |

Table 4 shows that expanded graphite is highly effective as graphite to be contained in the positive electrode (positive electrode mixture).

### Inventive Examples 18 to 21

Batteries E18 to E21 were produced and evaluated in the same manner as in the inventive example 5, except that the Ve/Vt ratio was changed as shown in Table 5. The results are shown in Table 5.

TABLE 5

| | E5 | E18 | E19 | E20 | E21 |
|---|---|---|---|---|---|
| BATTERY | 20 | ← | ← | ← | ← |
| DIAMETER | | | | | |
| (mm) | | | | | |
| BATTERY | 3.2 | ← | ← | ← | ← |
| THICKNESS | | | | | |
| (mm) | | | | | |
| T | 2.00 | ← | ← | ← | ← |
| (mm) | | | | | |
| DL | 0.04 | ← | ← | ← | ← |
| (mm) | | | | | |
| T/DL | 0.080 | ← | ← | ← | ← |
| GRAPHITE | 2.0 | ← | ← | ← | ← |
| CONTENT | | | | | |
| (wt %) | | | | | |
| B | LiBO₂ | ← | ← | ← | ← |
| COMPOUND | | | | | |
| GRAPHITE | EXPANDED | ← | ← | ← | ← |
| | GRAPHITE | | | | |
| Ve/Vt | 1.2 | 0.8 | 0.9 | 1.5 | 1.6 |
| BINDER | PTFE | ← | ← | ← | ← |
| INTERNAL | 35 | 51 | 43 | 42 | 52 |
| RESISTANCE | | | | | |
| (Ω) | | | | | |

Table 5 shows that the Ve/Vt ratio is preferably in the range of 0.9 to 1.5.

### Inventive Example 22

A battery E22 was fabricated and evaluated in the same manner as in Inventive example 5, except that the binder was changed to tetrafluoroethylene-hexafluoropropylene copolymer (hereinafter, referred to as FEP) as shown in Table 6. The results are shown in Table 6.

TABLE 6

| | E5 | E22 |
|---|---|---|
| BATTERY | 20 | ← |
| DIAMETER | | |
| (mm) | | |
| BATTERY | 3.2 | ← |
| THICKNESS | | |
| (mm) | | |
| T | 2.00 | ← |
| (mm) | | |
| DL | 0.04 | ← |
| (mm) | | |
| T/DL | 0.080 | ← |
| GRAPHITE | 2.0 | ← |
| CONTENT | | |
| (wt %) | | |
| B | LIBO₂ | ← |
| COMPOUND | | |
| GRAPHITE | EXPANDED | ← |
| | GRAPHITE | |
| Ve/Vt | 1.2 | ← |
| BINDER | PTFE | FEP |
| INTERNAL | 35 | 44 |
| RESISTANCE | | |
| (Ω) | | |

Table 6 shows that fibrous PTFE is preferably used as the binder.

### INDUSTRIAL APPLICABILITY

As described above, in the coin-shaped lithium primary battery according to the present disclosure, an increase in internal resistance is suppressed even after long-term storage at normal temperature in an unused state. Therefore, the recommended use period of the battery can be extended, and the battery has a large industrial value. In addition, the coin-shaped lithium primary battery is suitably used as a power source for a small device and memory backup.

### REFERENCE SIGNS LIST

3: Case
3a: Bottom plate portion
3b: Side portion
3t: End portion
4: Positive electrode
5: Negative electrode
6: Separator
7: Gasket
8: Sealing plate
8a: Top plate portion
8b: Peripheral edge portion
9: First curved portion
10: Second curved portion
11: Coin-shaped lithium primary battery

1. A coin-shaped lithium primary battery, comprising:
a positive electrode; a negative electrode; a separator disposed between the positive electrode and the negative electrode; and an electrolytic solution,
wherein
the positive electrode contains manganese dioxide, graphite, a binder, and a boron compound, and
a thickness T (mm) of the positive electrode and an average length DL (mm) of a long axis of the graphite satisfy the following formula:
0.02≤T (mm)×DL (mm)≤0.12.

2. The coin-shaped lithium primary battery according to claim 1, wherein
the graphite includes expanded graphite.

3. The coin-shaped lithium primary battery according to claim 1, wherein
a content of the graphite contained in the positive electrode is 1% by mass or more and 10% by mass or less.

4. The coin-shaped lithium primary battery according to claim 1, wherein
the boron compound is at least one selected from the group consisting of a boron oxide and a lithium-containing boron oxide.

5. The coin-shaped lithium primary battery according to claim 1, wherein
the boron compound is at least one selected from the group consisting of B₂O₃, Li₂B₄O₇, Li₃BO₃, and LiBO₂.

6. The coin-shaped lithium primary battery according to claim 1, wherein
a content of the boron compound contained in the positive electrode is 0.5% by mass or more and 5% by mass or less.

7. The coin-shaped lithium primary battery according to claim 1, wherein
a ratio (Ve/(Vp+Vs)) based on a volume Ve of the electrolytic solution, a void volume Vp of the positive electrode, and a void volume Vs of the separator is 0.9 or more and 1.5 or less.

8. The coin-shaped lithium primary battery according to claim 1, wherein
the binder contains a fibrous fluororesin.

9. The coin-shaped lithium primary battery according to claim 8, wherein
the fibrous fluororesin includes polytetrafluoroethylene.
